(19) United States
(12) Patent Application Publication
(10) Pub. No.: US 2021/0019908 A1
(43) Pub. Date: Jan. 21, 2021

(54) Building Recognition via Object Detection and Geospatial Intelligence

(71) Applicant: Microsoft Technology Licensing, LLC, Redmond, WA (US)

(72) Inventors: Yan Zhang, Bellevue, WA (US); Zhiqing Hong, Bellevue, WA (US); Chun-Ting Wu, Taipei (TW); Simon L. Shapiro, Bellevue, WA (US); Hao-Wei Tseng, Bellevue, WA (US); Qing Zhang, Bellevue, WA (US); Chih-Kai Wang, Bellevue, WA (US)

(73) Assignee: Microsoft Technology Licensing, LLC, Redmond, WA (US)

(21) Appl. No.: 16/511,836

(22) Filed: Jul. 15, 2019

(51) Int. Cl. G06T 7/73; G06T 11/40; G06K 9/62; G06K 9/00

(52) U.S. Cl. CPC G06T 7/73; G06T 11/40; G06K 9/6267; G06T 2210/12; G06K 9/00651; G06T 2207/20084; G06T 2207/30244; G06K 9/00637

(57) ABSTRACT

A method that enables building recognition via object detection and geospatial intelligence. The method includes detecting an object in an input image, wherein the object is located within a bounding area and extracting a physical location and a camera pose associated with the input image. The method also includes projecting a location coordinate of at least one entity onto the input image to obtain a projected point for the at least one entity, wherein the at least one entity is selected according to the physical location and camera pose associated with the input image and determining a nearest projected point to the bounding area. Finally, the method includes labeling the object within the bounding area with an entity name of the at least one entity associated with the nearest projected point.

### BACKGROUND

Generally, geospatial technology enables the capture, manipulation, processing, and storage of geographic data. The geographic data may in the form of a coordinate-based map that includes a representation of data associated with a physical location on Earth. In some cases, a map may be associated with a street side image. A street side image may be a real-world view of a physical location. The street side image may be aggregated with neighboring street side images to enable interactive viewing of the street side images.

### SUMMARY

The following Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

In an embodiment described herein, a method is described. The method includes detecting an object in an input image, wherein the object is located within a bounding area and extracting a physical location and a camera pose associated with the input image. The method also includes projecting a location coordinate of at least one entity onto the input image to obtain a projected point for the at least one entity, wherein the at least one entity is selected according to the physical location and camera pose associated with the input image and determining a nearest projected point to the bounding area. Finally, the method includes labeling the object within the bounding area with an entity name of the at least one entity associated with the nearest projected point.

In an embodiment described herein, a system is described. The system includes an object detector to detect an object in an input image, wherein the object is located within a bounding area. The system also includes a map infrastructure to extract a physical location and a camera pose associated with the input image. The system further includes a label assignor that is to project a location coordinate of at least one entity onto the input image to obtain a projected point for the at least one entity, wherein the at least one entity is selected according to the physical location and camera pose associated with the input image and determine that the projected point is a nearest projected point to the bounding area. The label assignor is also to label the object within the bounding area with an entity name of the entity associated with the nearest projected point.

In an embodiment described herein, a computer readable medium is described. The computer readable medium, in execution, includes detecting an object in an input image, wherein the object is located within a bounding area and extracting a physical location and a camera pose associated with the input image. The computer readable medium, in execution, also includes projecting a location coordinate of at least one entity onto the input image to obtain a projected point for the at least one entity, wherein the at least one entity is selected according to the physical location and camera pose associated with the input image and determining that the projected point is a nearest projected point to the bounding area. Finally, the computer readable medium, in execution, includes labeling the object within the bounding area with an entity name of the at least one entity associated with the nearest projected point.

The following description and the annexed drawings set forth in detail certain illustrative aspects of the claimed subject matter. These aspects are indicative, however, of a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

The following detailed description may be better understood by referencing the accompanying drawings, which contain specific examples of numerous features of the disclosed subject matter.

FIG. 1 is a block diagram illustrating objection detection according to the present techniques;

FIG. 2 is an illustration of an input image;

FIG. 3 is an illustration of a map obtained from a map infrastructure;

FIG. 4 is an illustration of projection of a coordinate point;

FIG. 5 is a street side image;

FIG. 6 is an illustration of a street side image;

FIG. 7 is a process flow diagram of a method for building recognition via object detection and geospatial intelligence;

FIG. 8 is a block diagram illustrating an exemplary computer readable medium encoded with instructions to enable building recognition via object detection and geospatial intelligence according to aspects of the disclosed subject matter;

FIG. 9 is a block diagram illustrating an exemplary computing device configured to enable building recognition via object detection and geospatial intelligence according to aspects of the disclosed subject matter; and

FIG. 10 is a block diagram illustrating an exemplary network environment suitable for implementing aspects of the disclosed subject matter.

### DETAILED DESCRIPTION

A street side image may be a view or representation of a physical space. In some cases, the street side image may be a view or representation of a physical space captured at a wide angle. The street side images may be referred to as panoramas, and may be managed by a web mapping service. While the present techniques are described using street side images, any type of image may be used. The street side images often include imagery of structures such as buildings, landmarks, churches, monuments, statues, roads, highways, and the like. In some cases, structures may include objects that occur naturally in nature, such as mountains, forests, rivers and canyons.

When viewing a street side image, an identification of the structure may not be immediately visible. Moreover, the identification of the structure may not be immediately ascertainable from the street side image. For example, neighboring buildings often have similar architectural features, making them visually similar. Moreover, markings such as addresses may be small, difficult to see, or obscured by other objects. As a result, it can be difficult to find an entity that is located in a building that is visually similar to other, neighboring buildings. Moreover, street images are typically stale and lack any rich information, such as names of landmarks contained in the street images.

The present techniques enable building recognition via object detection and geospatial intelligence. In embodiments, a street side image is enriched with building recognition via object detection and building identification based on geospatial intelligence. Conventional techniques often require three-dimensional data to determine a building label. Moreover, conventional techniques do not combine object detection with the building labeling. Instead, conventional techniques obtain various projections using three-dimensional data. The present techniques enable street side images with building identification, without the use of three-dimensional data.

The present techniques enable recognition of structures in a street side image as a class of objects in an object detection algorithm. In particular, object detection is used to identify buildings in the street side image via location coordinates and a size of a bounding box. The street side image, along with orientation information of the street side image, may be used to project geospatial information into the street side image. Orientation information may be, for example, a compass signal that indicates the heading of an observer at a particular location. In particular, the compass signal may be a global positioning system (GPS) data and an orientation. Metadata associated with a street side image often includes GPS data or coordinates of a scene captured by the input image, as well as an orientation or heading used when capturing the scene as represented by the street view image.

Using a heading and coordinates, geospatial information from a map infrastructure map be associated with the street view image at the particular heading and coordinates of the observer. As used herein, associating the geospatial information with the street view image may refer to defining geospatial data of structures visible in the street view image. In particular, for each bounding box found in a street side image, geospatial data may be searched to obtain an entity located at a physical location within the bounding box found in the street side image. The geospatial data may include GPS coordinates belonging to a particular entity. The GPS coordinates of entities may be projected onto the street side image. The entity corresponding to a projected point that is nearest a bounding box is selected as a label or identification of the bounding box. In this manner, the geospatial techniques described herein attach rich entity information to the buildings detected in street side images. The present techniques are scalable to millions of buildings, and are not limited to famous or well-known landmarks. As used herein, an entity is any organization or thing with an independent existence. An entity is associated with a physical location. For example, a business entity may be a corporation. An entity may also be, for example, Mt. Rainier or a particular street.

For ease of description, the present techniques are described using street side images or panoramas with buildings described as the detected class of objects during object detection. However, the present techniques may be applied to any type of image. Moreover, the classes of objects detected may include various tangible objects. Accordingly, the present techniques may generally detect an object via object detection, and use geospatial data associated with the location of the object to apply a label to the object. In an embodiment, the label applied to the object may serve to identify the object. In another embodiment, the label applied to the object may serve to attach other data to the object. The present techniques may be used to enable an observer to view street side images and accurately locate entities in advance of a visit to the physical location. In particular, the images can have the visual atmosphere of a location, with the present techniques adding additional information for a better user experience, such as identifying shops, businesses, and churches.

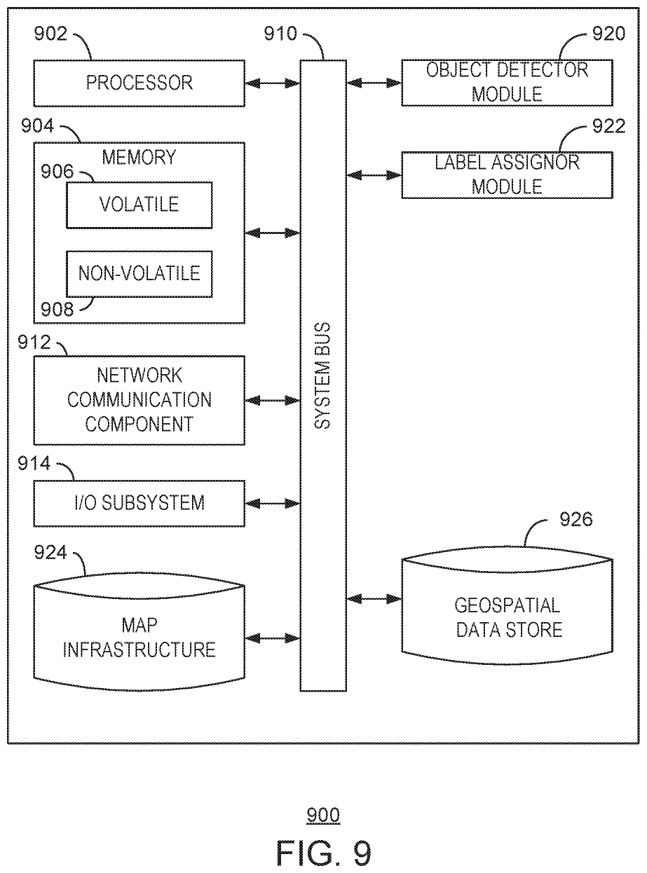

As a preliminary matter, some of the figures describe concepts in the context of one or more structural components, referred to as functionalities, modules, features, elements, etc. The various components shown in the figures can be implemented in any manner, for example, by software, hardware (e.g., discrete logic components), firmware, and so on, or any combination of these implementations. In one embodiment, the various components may reflect the use of corresponding components in an actual implementation. In other embodiments, any single component illustrated in the figures may be implemented by a number of actual components. The depiction of any two or more separate components in the figures may reflect different functions performed by a single actual component. FIG. 9 discussed below provides details regarding different systems that may be used to implement the functions shown in the figures.

Other figures may describe the concepts in flowchart form. In this form, certain operations are described as constituting distinct blocks performed in a certain order. Such implementations are exemplary and non-limiting. Certain blocks described herein can be grouped together and performed in a single operation, certain blocks can be broken apart into plural component blocks, and certain blocks can be performed in an order that differs from that which is illustrated herein, including a parallel manner of performing the blocks. The blocks shown in the flowcharts can be implemented by software, hardware, firmware, and the like, or any combination of these implementations. As used herein, hardware may include computer systems, discrete logic components, such as application specific integrated circuits (ASICs), and the like, as well as any combinations thereof.

As for terminology, the phrase “configured to” encompasses any way that any kind of structural component can be constructed to perform an identified operation. The structural component can be configured to perform an operation using software, hardware, firmware and the like, or any combinations thereof. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware.

The term “logic” encompasses any functionality for performing a task. For instance, each operation illustrated in the flowcharts corresponds to logic for performing that operation. An operation can be performed using software, hardware, firmware, etc., or any combinations thereof.

As utilized herein, terms “component,” “system,” “client,” and the like are intended to refer to a computer-related entity, either hardware, software (e.g., in execution), and/or firmware, or a combination thereof. For example, a component can be a process running on a processor, an object, an executable, a program, a function, a library, a subroutine, and/or a computer or a combination of software and hardware. By way of illustration, both an application running on a server and the server can be a component. One or more components can reside within a process and a component can be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any tangible, computer-readable device, medium, or media.

Computer-readable storage media can include but are not limited to magnetic storage devices (e.g., hard disk, floppy disk, and magnetic strips, among others), optical disks (e.g., compact disk (CD), and digital versatile disk (DVD), among others), smart cards, and flash memory devices (e.g., card, stick, and key drive, among others). In contrast, computer-readable media generally (i.e., not storage media) may additionally include communication media such as transmission media for wireless signals and the like. The communication media may include cables, such as fiber optic cables, coaxial cables, twisted-pair cables, and the like. Moreover, transmission media for wireless signals may include hardware that enables the transmission of wireless signals such as broadcast radio waves, cellular radio waves, microwaves, and infrared signals. In some cases, the transmission media for wireless signals is a component of a physical layer of a networking stack of an electronic device. While computer-readable media may reproduce and/or cause to deliver the computer-executable instructions and data to a computing device for execution by one or more processor via various transmission means and mediums including carrier waves and/or propagated signals, for purposes of this disclosure computer readable media or a computer readable medium expressly excludes carrier waves and/or propagated signals.

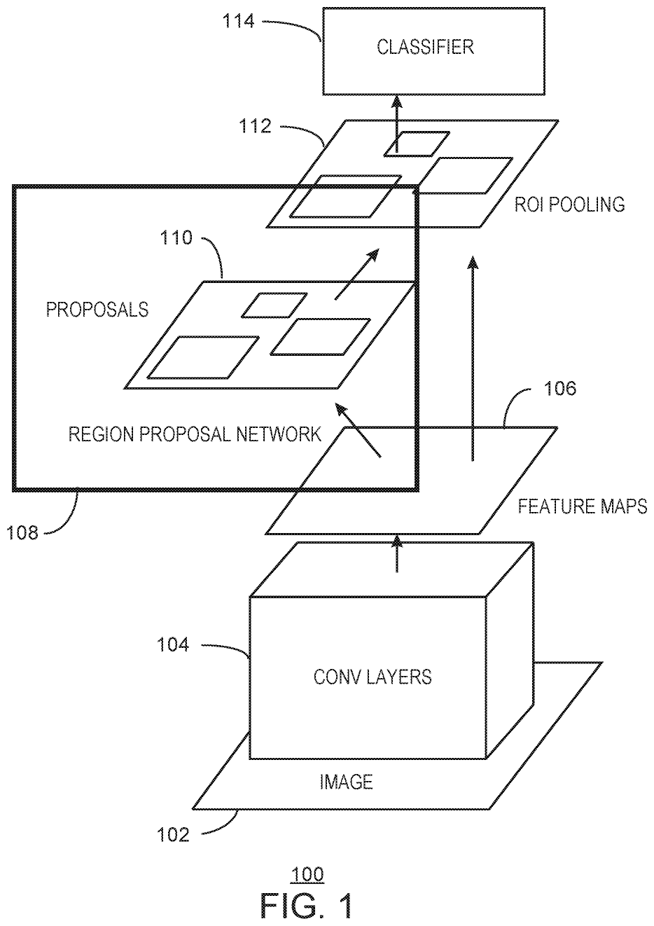

FIG. 1 is a block diagram illustrating objection detection 100 according to the present techniques. In embodiments, object detection is used to locate or discover instances of semantic objects in images or videos. The semantic object may be classified according a to class. In embodiments, the class defines a category of objects detected in an image, such as persons, buildings, or cars. The class may generally include attributes that define an identifiable object in digital images and videos. Thus, object detection enables detecting instances of semantic objects according to class in digital images and videos. The object detection according to the present techniques derives a bounding box around the detected object and a location of the bounding box. The location may be described by coordinates in the street view image. Thus, object detection outputs a set of coordinates and a size of a bounding box to be located at the coordinates. Note that the bounding box is located on a plane where the image is projected, also referred to as an image plane. While the present techniques refer to an image plane, any camera plane may be used for object detection as well as the projection of entity coordinates. For example, the present techniques may project points onto a focal plane of the camera.

Object detection, as described herein, may be implemented according to a Faster R-CNN (recurrent convolutional neural network) algorithm to detect objects, such as structures in a street side image. Faster R-CNN first implements a convolutional neural network (CNN) to extract features from input images. In FIG. 1, an image 102 is input to a CNN 104. The image 102 may be any image, such as a two-dimensional (2D) image. The image 102 may also be a street side image, panorama, or wide-angle image. The present techniques enable the detection of a building in the street side image and an application of a label to the detected buildings based on two-dimensional image data.

The image 102 may be input into a convolutional neural network (CNN) 104. The CNN 104 may be a deep convolutional neural network with a plurality of convolutions and max-pooling layers. In embodiments, the CNN 104 comprises a plurality of convolutional layers. The CNN 104 extracts features from the image 102. In embodiments, the CNN 104 may process the image 102 to obtain one or more features. The one or more features may be represented by feature maps 106.

At a region proposal network (RPN) 108, a number of region proposals 110 may be generated. The RPN 108 detects a number of regions that may contain objects. A region may be identified by a bounding box. Thus, the RPN 108 may output a location coordinate and size of a candidate region or bounding box. The RPN 108 according to the present techniques is enabled via the CNN 104, and takes features from the feature maps 106 extracted by the CNN 104 and calculates a number of region proposals 110. The region proposals 110 represent an area of the input image where an object may be located. Thus, each proposal 110 is a candidate area or region of the input image where an object may be located.

To determine a proposal, the RPN 108 may define an anchor as a central point of a sliding window applied to the feature maps 106. For each anchor, the RPN may determine a probability that the anchor includes an object. Additionally, for each anchor a regression analysis may be applied to a bounding box containing the anchor to adjust the fit of the bounding box to the potential object being detected. In this manner, the RPN 108 is able to determine a number of region proposals 110 detected in the image 102. For ease of description, the region proposals 110 are described as being determined via a region proposal network. However, the region proposals may be determined according to other techniques. For example, the region proposals may be determined by extracting regions of interest from the image 102 or the feature map 106.

The CNN 104 is executed to generate region proposals 110 and to classify objects by the classifier 114. The proposals may be sent to region of interest (RoI) pooling 112. Additionally, the features extracted by CNN 104 are also sent to the RoI pooling 112. In some cases, proposals 110 overlap in an effort to identify a same object in a street side image. To reduce duplicate proposals, the proposals may be sorted according to a probability that the proposal contains an object. The proposals that have an intersection over union (IoU) that is greater than a predefined threshold may be discarded and replaced with an overlapping proposal that has a higher probability of containing the object. In embodiments, Faster R-CNN uses a non-maximum suppression to discard objects whose IoU is greater than 0.5.

Thus, RoI pooling 112 takes as input a feature map obtained from the CNN 104 and the proposals 110. In embodiments, the feature map 106 may be fixed in size. The RoI pooling 112 may enforce a cropped feature map dimension of 3×3. The RoI pooling 112 may also divide an input feature map into a fixed number of approximately equal regions. Max pooling is then performed on all inputs to obtain a plurality of fixed size feature maps that correspond to each proposal. In some embodiments, the proposals may be represented in a matrix format, where the matrix includes coordinates of the top left and bottom right corners of the proposed region. Additionally, the RoI pooling 112 make take each proposal and scale the proposal to a pre-defined size.

The classifier 114 may use the fixed size features extracted via the RoI pooling 112 to classify the content in each proposed region. According to the present techniques, the features are classified as a structure, such as a building, or otherwise discarded. In embodiments, the background class is a class used to discard erroneous or bad proposals. A proposal may be considered erroneous or bad when the proposal does not correspond to an object. When discarding features, the features may be classified as the background. In embodiments, the classifier may also further adjust the bounding box coordinates to provide a closer fit of the detected object. The bounding box for the proposed region may be adjusted according to the predicted class.

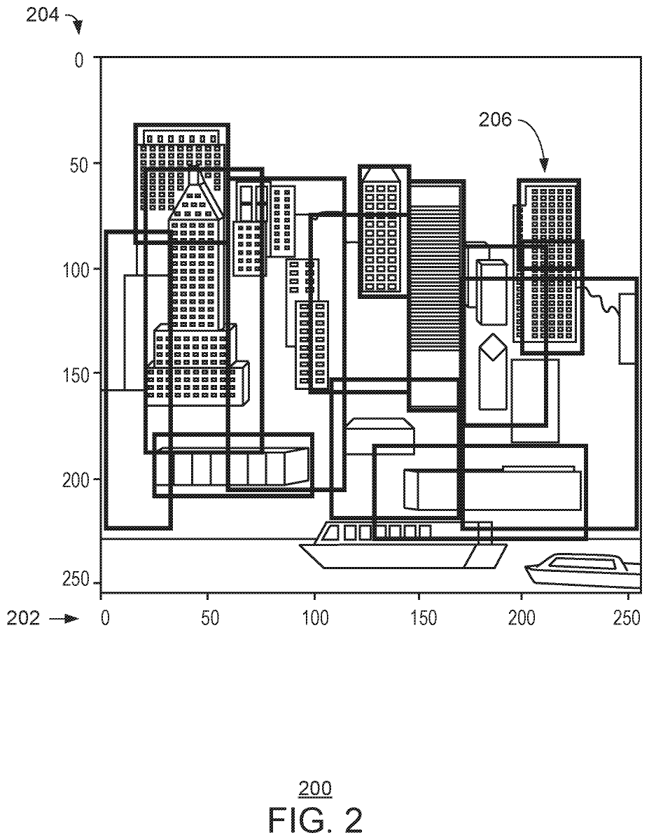

FIG. 2 is an illustration of an input image 200. The input image 200 is illustrated atop of a coordinate plane with in X-axis 202 and a Y-axis 204. The input image 200 includes a plurality of bounding boxes 206. Each of the bounding boxes 206 represents an area of the image where an object has been detected. According to the present techniques, the detected objects are structures, such as a building.

Conventional techniques can recognize famous, popular landmarks, such as the Statue of Liberty or the Space Needle, and do not detect generic objects, such as structures. Instead, conventional object detection is limited to a subset of structures, such as famous landmarks, as the three-dimensional data used in conventional implementations of the object detection model cannot scale to millions of buildings and businesses. The present techniques combine object detection with geospatial data, which enables the detection and identification of millions of structures while using geospatial data to identify entities associated with each structure.

Geospatial data is used to label structures according to the present techniques. Geospatial data may refer to data with a geographic component. The geospatial data includes entities that are tied to geographic coordinates. In embodiments, an entity may be associated with a location coordinate by being located at the location coordinate. Geospatial data may be obtained and stored by a geospatial engine. In embodiments, the geospatial engine manages access to a searchable data store. Geospatial data as referred to herein includes rich entity and building information associated with a location. The entity and building information includes, but is not limited to, business name, hours of operation, phone number, website, reviews, complaints, history, and other data associated with a particular building or entity.

In embodiments, rich business and building geospatial data is stored on a geospatial platform in a data structure that is formatted to enable efficient nearest neighbor searches or range searches of the geospatial data. For example, the data structure may be a k-dimensional (k-d) tree or an R-tree. A k-d tree organizes points in a k-dimensional space. Each leaf node of a k-d tree is a k-dimensional point. At higher levels of the k-d tree, each node may divide the k-dimensional space into two separate parts. Similarly, an R-tree may be used to index geospatial data, including geographical coordinates. At the leaves of the R-tree, a rectangle defines a single object. At higher levels of the R-tree, nearby objects are grouped and represented by a minimum bounding rectangle.

Geospatial data from the data structure, such as the k-d tree or the R-tree, may be organized into pages for storage on disk, in a data store, or in a database. A map infrastructure may be used to provide street side images. The map infrastructure may include a set of points for each street side image. The set of points are as captured at a particular heading and location. In order to determine the entity associated with each structure detected during object detection as described above, a location (coordinates) and camera pose (tilt, orientation) is extracted from the street side image.

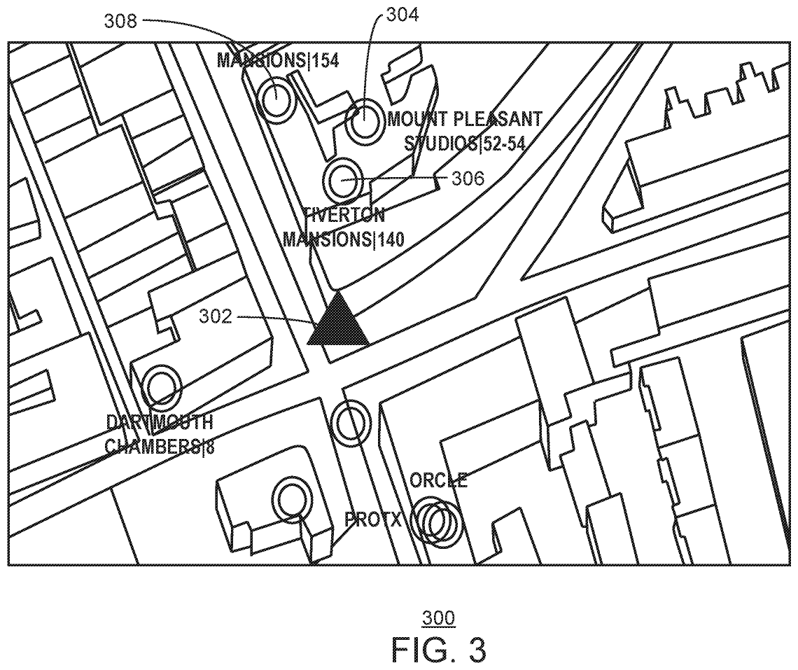

FIG. 3 is an illustration of a map 300 obtained from a map infrastructure. In embodiments, the identity of a particular building in a street side image may be determined using geospatial data and perspective projection techniques based on the map 300. In embodiments, a street side image may correspond to a location 302 on the map 300. The location 302 is indicated by a triangle. With respect to FIG. 3, the top of the triangle indicates a user's orientation with respect to entities 304, 306, and 308. The entities 304, 306, and 308 are located in structures that may be visible in a street view of the image. As illustrated, the entity 304 corresponds to “Mount Pleasant Studios.” The entity 306 corresponds to “Tiverton Mansions.” Finally, the entity 308 corresponds to “Mansions.”

Each of the entities 304, 306, and 308 may be projected into a street side image of an observer. The street side image may be captured at location 302 and oriented as indicated by the triangle that represents the location 302. As described above, object detection is used to determine a number of structures visible in the view of an observer. In particular, a bounding box is detected for each structure within the observer's view. As described below, a nearest point bounded in the proposed region is selected as a name of the structure.

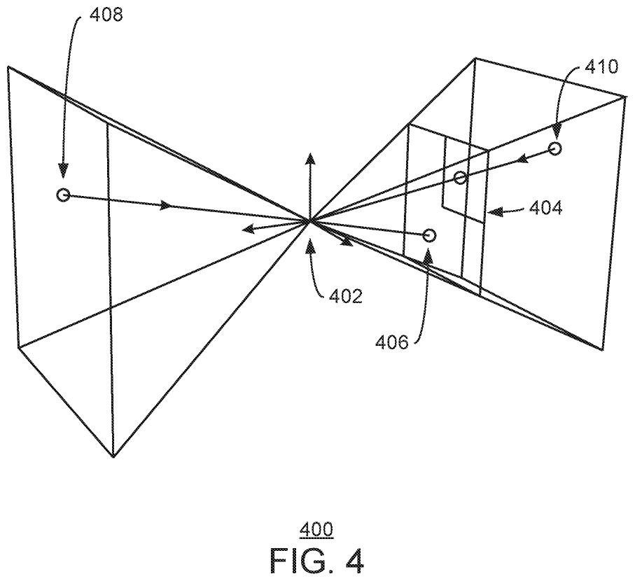

FIG. 4 is an illustration of projection of a coordinate point. The coordinate point may be considered the camera center as indicated by reference number 402. Reference number 404 indicates an image plane. At reference number 406, a projection is illustrated that mirrors point coordinates. Reference number 408 represents a point behind the camera. Similarly, reference number 410 represents the same point in front of the camera. In embodiments, a corresponding camera pose and user location coordinates are obtained from data associated with a street side image. In embodiments, the camera pose, location coordinates, and orientation/heading may be stored in metadata of the street side image. The present techniques take as input the camera pose and location coordinates of the image to determine the particular structures to be projected in the observer's view. This perspective projection enables the determination of coordinates of a structure in the observer's view. The coordinates as extracted from the observer's view may be compared to stored geospatial data. The nearest point bounded in the proposed region is selected as a name of the structure.

As discussed above, each street side image includes a location coordinate of the real-world point where the image capture occurred, as well as an orientation of the camera when the image capture occurred. The bounding boxes derived in the street side image occur in the image plane of the camera. In embodiments, entities within a predetermined radius of the location coordinate of the real-world point where the image capture occurred are selected as potential candidates to be projected onto the street side image. In embodiments, the orientation associated with the street side may be further used to derive one or more entities that can be observed or viewed within the street side image. The location coordinates of one or more entities are then projected onto the image plane associated with the street side image. In this manner, the bounding boxes derived via object detection and the location coordinates associated with one or more entities are transformed or projected to lie on a common plane. The bounding boxes and location coordinates can be compared to determine which of the one or more entities is associated with each bounding box. In embodiments, a location coordinate associated with an entity is selected as a nearest projected point when it has a smallest distance to a bounding box or is within the bounding box. In the case of a building that houses multiple entities, a plurality of nearest projected points may be determined.

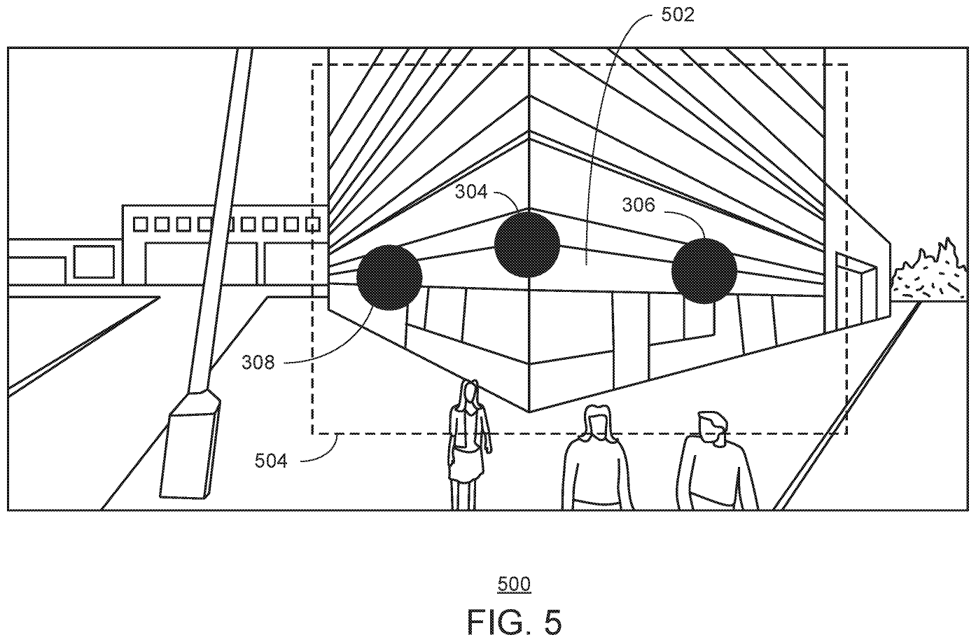

FIG. 5 is a street side image 500. The street side image 500 includes a structure 502. The structure 502 is surrounded by a bounding box 504. The bounding box 504 may be determined via object detection techniques as described above. Based on the bounding box, candidate structures as obtained from a map infrastructure may be projected into the observer's view. A search may be executed to determine a nearest neighbor in the geospatial data of the bounding box coordinates. In this manner, a particular building can be identified from the geospatial data based on the coordinates of the bounding box derived from object detection as described above. In the example of FIG. 5, it may be determined that the structure within the bounding box 504 corresponds to the “Tiverton Mansions” as illustrated in FIG. 3.

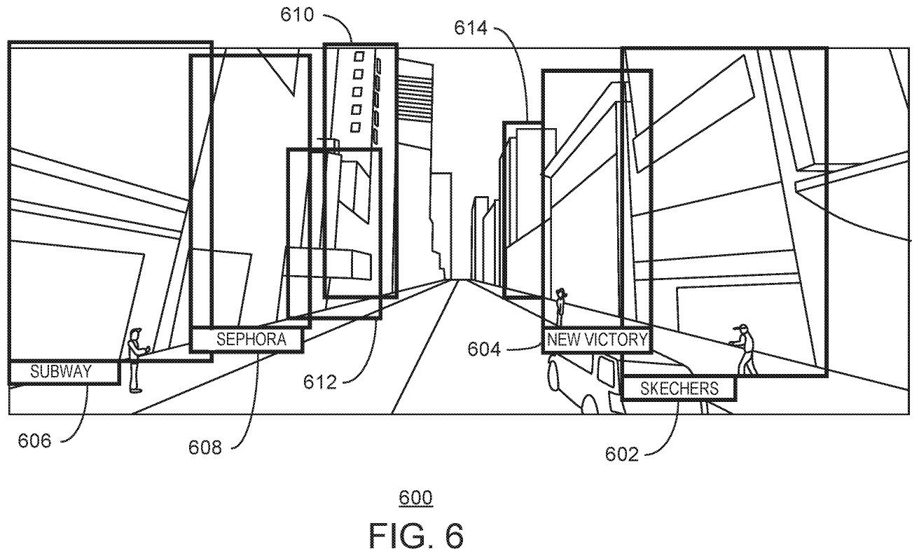

FIG. 6 is an illustration of a street side image 600. In the street view 600, several detected buildings are illustrated along a street 620. The detected buildings are identified by a bounding box. In particular, the street side image 600 includes bounding boxes 602, 604, 606, 608, 610, 612, and 614. Using the techniques described above, labels may be applied to each bounding box that identifies the entity associated with a physical location of the building. In the example of FIG. 6, bounding box 602 is associated with a shoe store. Similarly, bounding box 604 is associated with a business named “New Victory.” Bounding box 606 is associated with entity “Burger Queen.” Finally, bounding box 608 may be associated with a makeup store.

As illustrated, structures along street 620 may be visually similar to other buildings nearby. Moreover, several entities may occupy the same building. According to the techniques described herein, each entity can be identified in a street side image. Thus, an observer can readily identify various entities within a street side image. An observer may have additional confidence in directions based on the identification of entities and street side images prior to the observer physically visiting locations seen in the street side images.

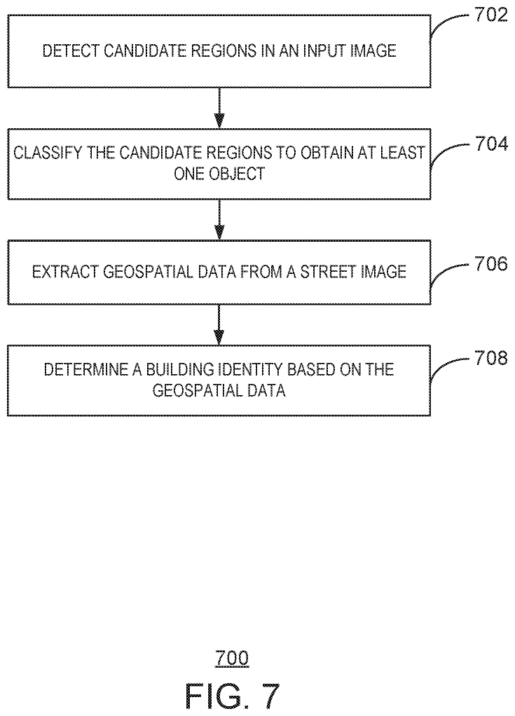

FIG. 7 is a process flow diagram of a method 700 for building recognition via object detection and geospatial intelligence. In embodiments, points obtained from geospatial data may be projected into a street side image. In this manner, map points may be attached to street side image. At block 702, candidate regions are detected in an street side image. In embodiments, candidate regions may be proposals as generated by a Faster R-CNN algorithm. The candidate regions represent areas of an street side image where a structure generally occurs. In embodiments, the structure may be a building, landmark, attraction, road, an object that marks a particular location, or any combination thereof. At block 704, a candidate region is classified to determine a bounding box for an object of the image. In embodiments, classifying the candidate region may include discarding duplicates or overlapping candidate regions. Classifying the candidate region may also include adjusting a bounding box that defines the candidate region based on the particular classification of the region.

In embodiments, the street side image is a two-dimensional image, and the existence of a building may be determined using the 2D image. The output of object detection is a coordinate of the bounding box along with a size of the bounding box. In embodiments, object detection may be implemented using a Faster R-CNN algorithm. The Faster R-CNN according to the present techniques may classify objects as belonging to a single class and output coordinate for the bounding box and a size of the bounding box for objects in the single class. In embodiment, the single class may be a building. Additionally, in embodiments the single class may be a structure. The bounding boxes of detected objects may be regressed to closely fit the boundary of a proposed object. In this manner, the bounding boxes can be adjusted to fit the size of the object.

At block 706, geospatial data is projected onto the street side image. As described above, object detection determines the existence of a building within a particular bounding box. Geospatial data, such as map data may be injected into the street side image. Map data may be injected into the street side image by matching a projected point from the geospatial data with a bounding box in the street side image.

At block 708 a building label is determined based on the geospatial data. Based on entities at points projected onto the street side image, a determination is made as to which entity from the map infrastructure/geospatial data corresponds to the bounding box. In particular, the physical location and camera pose may be extracted from metadata of a street side image. The location coordinate of an entity is projected onto the street side image to obtain a projected point for the at least one entity. Projecting the location coordinate of the entity onto the street side image may refer to transforming the location coordinate to a point on a same plane of the street side image. In embodiments, a nearest neighbor search may be executed to match the bounding box with the geospatial data of a particular entity.

The points projected onto the street side image for each entity may be GPS coordinates. The present techniques can then determine which bounding box contains a particular GPS coordinate. The one or more entities that are physically located at particular GPS point may be associated with the bounding box that includes the GPS point as projected into the street side image. The entity located at the nearest point bounded in the region is selected as the label the bounding box.

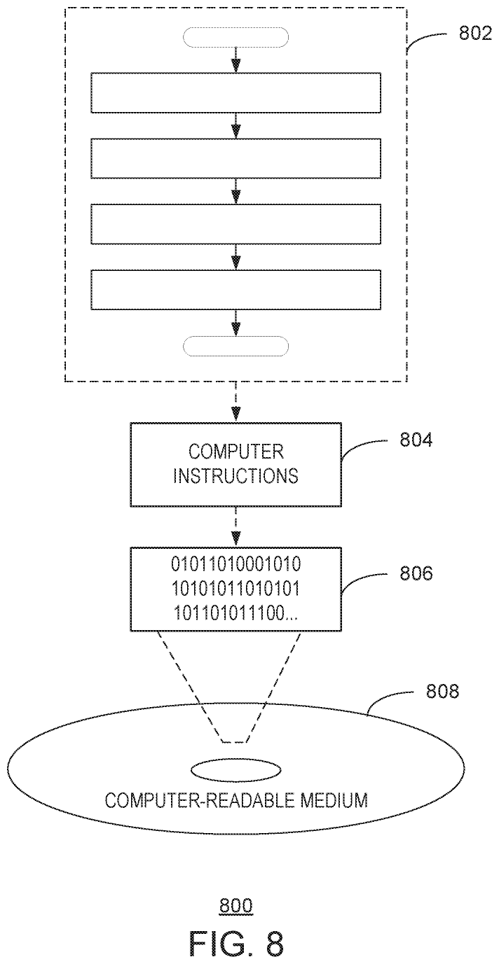

Turning to FIG. 8, FIG. 8 is a block diagram illustrating an exemplary computer readable medium encoded with instructions to enable building recognition via object detection and geospatial intelligence according to aspects of the disclosed subject matter. More particularly, the implementation 800 comprises a computer-readable medium 808 (e.g., a CD-R, DVD-R or a platter of a hard disk drive), on which is encoded computer-readable data 806. This computer-readable data 806 in turn comprises a set of computer instructions 804 configured to operate according to one or more of the principles set forth herein. In one such embodiment 802, the processor-executable instructions 804 may be configured to perform a method, such as at least some of the exemplary method 700 of FIG. 7, for example. In another such embodiment, the processor-executable instructions 804 may be configured to implement a system, such as at least some of the exemplary system 900 of FIG. 9, as described below. Many such computer-readable media may be devised by those of ordinary skill in the art that are configured to operate in accordance with the techniques presented herein.

Turning to FIG. 9, FIG. 9 is a block diagram illustrating an exemplary computing device 900 configured to enable building recognition via object detection and geospatial intelligence according to aspects of the disclosed subject matter. The exemplary computing device 900 includes one or more processors (or processing units), such as processor 902, and a memory 904. The processor 902 and memory 904, as well as other components, are interconnected by way of a system bus 910. The memory 904 typically (but not always) comprises both volatile memory 906 and non-volatile memory 908. Volatile memory 906 retains or stores information so long as the memory is supplied with power. By contrast, non-volatile memory 908 is capable of storing (or persisting) information even when a power supply is not available. Generally speaking, RAM and CPU cache memory are examples of volatile memory 906 whereas ROM, solid-state memory devices, memory storage devices, and/or memory cards are examples of non-volatile memory 908.

The processor 902 executes instructions retrieved from the memory 904 (and/or from computer-readable media, such as computer-readable medium 808 of FIG. 8) in carrying out various functions of information sharing in a collaborative privacy conscious environment as described above. The processor 902 may be comprised of any of a number of available processors such as single-processor, multi-processor, single-core units, and multi-core units.

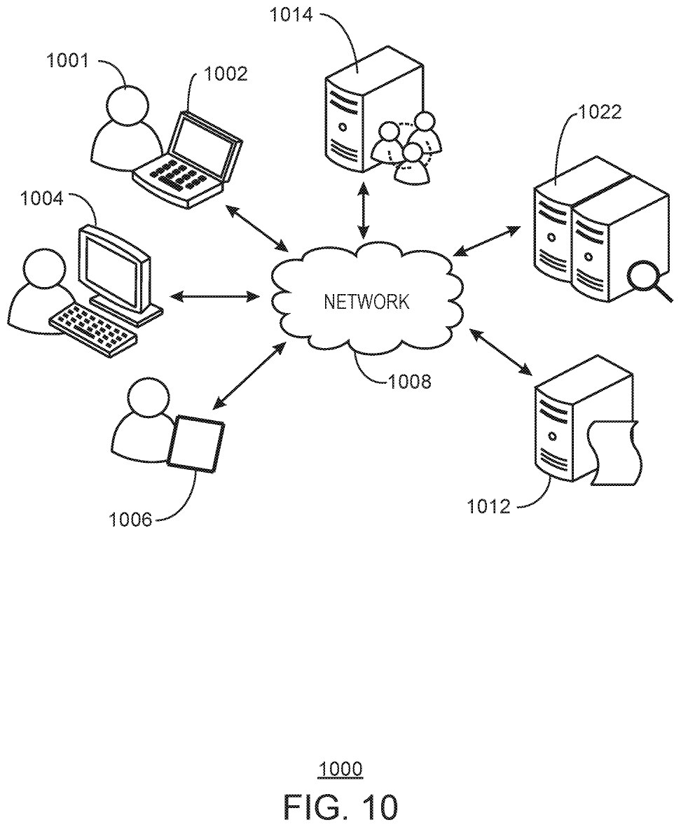

Further still, the illustrated computing device 900 includes a network communication component 912 for interconnecting this computing device with other devices and/or services over a computer network, including other user devices, such as user computing devices 1004, 1006, and 1010 as illustrated in FIG. 10. The network communication component 912, sometimes referred to as a network interface card or NIC, communicates over a network (such as network 1002) using one or more communication protocols via a physical/tangible (e.g., wired, optical, etc.) connection, a wireless connection, or both. As will be readily appreciated by those skilled in the art, a network communication component, such as network communication component 912, is typically comprised of hardware and/or firmware components (and may also include or comprise executable software components) that transmit and receive digital and/or analog signals over a transmission medium (i.e., the network.)

The computing device 900 also includes an I/O subsystem 914. As will be appreciated, an I/O subsystem comprises a set of hardware, software, and/or firmware components that enable or facilitate inter-communication between a user of the computing device 900 and the processing system of the computing device 900. Indeed, via the I/O subsystem 914 a computer operator may provide input via one or more input channels such as, by way of illustration and not limitation, touch screen/haptic input devices, buttons, pointing devices, audio input, optical input, accelerometers, and the like. Output or presentation of information may be made by way of one or more of display screens (that may or may not be touch-sensitive), speakers, haptic feedback, and the like. As will be readily appreciated, the interaction between the computer operator and the computing device 900 is enabled via the I/O subsystem 914 of the computing device.

The computing device 900 further comprises an object detector 920 and a label assignor 924. The object detector 920 and label assignor 924 may be independent executable modules that are configured (in execution) as follows. In operation/execution, the object detector detects objects in an input image. The label assignor 920 may assign a label to detect objects by projecting geospatial data onto the input image. The geospatial data may be stored in a geospatial data store 926. The geospatial data store may include geospatial data stored in a data structure that enables efficient searching and retrieval of geospatial data. Street side images may be stored in a map infrastructure 924.

Turning now to FIG. 10, FIG. 10 is a block diagram illustrating an exemplary network environment 1000 suitable for implementing aspects of the disclosed subject matter. The network environment 1000 includes user computers 1002, and 1004, 1006, and 1014. As suggested above, observer, such as computer user 1001, views a street side image obtained from a map infrastructure 924. The map infrastructure and geospatial data store may be located on a computing device 1022 coupled with the network 1008. To enrich the street side image presented to the observer 1001, the geospatial data may be projected onto the street side image and buildings in the street side image may be labeled or identified according to the entities found in the geospatial data.

While various novel aspects of the disclosed subject matter have been described, it should be appreciated that these aspects are exemplary and should not be construed as limiting. Variations and alterations to the various aspects may be made without departing from the scope of the disclosed subject matter.

### EXAMPLES

Example 1 is a method. The method includes detecting an object in an input image, wherein the object is located within a bounding area; extracting a physical location and a camera pose associated with the input image; projecting a location coordinate of at least one entity onto the input image to obtain a projected point for the at least one entity, wherein the at least one entity is selected according to the physical location and camera pose associated with the input image; determining that the projected point is a nearest projected point to the bounding area; and labeling the object within the bounding area with an entity name of the at least one entity associated with the nearest projected point.

Example 2 includes the method of example 1, including or excluding optional features. In this example, the object is a structure.

Example 3 includes the method of any one of examples 1 to 2, including or excluding optional features. In this example, detecting the object comprises obtaining one or more candidate regions and classifying each proposed candidate region as containing an object or being a background region.

Example 4 includes the method of any one of examples 1 to 3, including or excluding optional features. In this example, the bounding area is defined by a location on an image plane and a size of the bounding area.

Example 5 includes the method of any one of examples 1 to 4, including or excluding optional features. In this example, the at least one entity is within a predetermined radius of the physical location associated with the input image.

Example 6 includes the method of any one of examples 1 to 5, including or excluding optional features. In this example, the object is detected according to a Faster R-CNN algorithm that detects a single class of objects.

Example 7 includes the method of any one of examples 1 to 6, including or excluding optional features. In this example, the location coordinate of the at least one entity is a GPS coordinate.

Example 8 includes the method of any one of examples 1 to 7, including or excluding optional features. In this example, the location coordinate of the at least one entity is stored in a geospatial data store that comprises geospatial data stored in a data structure that is formatted to enable an efficient nearest neighbor search.

Example 9 includes the method of any one of examples 1 to 8, including or excluding optional features. In this example, the entity name indicates a business organization that operates at the location coordinate of the at least one entity.

Example 10 includes the method of any one of examples 1 to 9, including or excluding optional features. In this example, the object is a building, landmark, church, monument, statue, road, or highway.

Example 11 is a system. The system includes an object detector to detect an object in an input image, wherein the object is located within a bounding area; a map infrastructure to extract a physical location and a camera pose associated with the input image; and a label assignor to: project a location coordinate of at least one entity onto the input image to obtain a projected point for the at least one entity, wherein the at least one entity is selected according to the physical location and camera pose associated with the input image; determine that the projected point is a nearest projected point to the bounding area; and label the object within the bounding area with an entity name of the at least one entity associated with the nearest projected point.

Example 12 includes the system of example 11, including or excluding optional features. In this example, the object is a structure.

Example 13 includes the system of any one of examples 11 to 12, including or excluding optional features. In this example, detecting the object comprises obtaining one or more candidate regions and classifying each proposed candidate region as containing an object or being a background region.

Example 14 includes the system of any one of examples 11 to 13, including or excluding optional features. In this example, the at least one entity is within a predetermined radius of the physical location associated with input image.

Example 15 includes the system of any one of examples 11 to 14, including or excluding optional features. In this example, the object is detected according to a Faster R-CNN algorithm that detects a single class of objects.

Example 16 is a computer readable medium bearing computer executable instructions which. The computer-readable medium includes instructions that direct the processor to detecting an object in an input image, wherein the object is located within a bounding area; extracting a physical location and a camera pose associated with the input image; projecting a location coordinate of at least one entity onto the input image to obtain a projected point for the at least one entity, wherein the at least one entity is selected according to the physical location and camera pose associated with the input image; determining that the projected point is a nearest projected point to the bounding area; and labeling the object within the bounding area with an entity name of the at least one entity associated with the nearest projected point.

Example 17 includes the computer-readable medium of example 16, including or excluding optional features. In this example, detecting the object comprises obtaining one or more candidate regions, and classifying each proposed candidate region as containing an object or being a background region.

Example 18 includes the computer-readable medium of any one of examples 16 to 17, including or excluding optional features. In this example, the location coordinate of the at least one entity is stored in a geospatial data store that comprises geospatial data stored in a data structure that is formatted to enable an efficient nearest neighbor search.

Example 19 includes the computer-readable medium of any one of examples 16 to 18, including or excluding optional features. In this example, the entity name indicates a business organization that operates at the location occupied by the building.

Example 20 includes the computer-readable medium of any one of examples 16 to 19, including or excluding optional features. In this example, the object is a building, landmark, church, monument, statue, road, or highway.

In particular and in regard to the various functions performed by the above described components, devices, circuits, systems and the like, the terms (including a reference to a “means”) used to describe such components are intended to correspond, unless otherwise indicated, to any component which performs the specified function of the described component, e.g., a functional equivalent, even though not structurally equivalent to the disclosed structure, which performs the function in the herein illustrated exemplary aspects of the claimed subject matter. In this regard, it will also be recognized that the innovation includes a system as well as a computer-readable storage media having computer-executable instructions for performing the acts and events of the various methods of the claimed subject matter.

There are multiple ways of implementing the claimed subject matter, e.g., an appropriate API, tool kit, driver code, operating system, control, standalone or downloadable software object, etc., which enables applications and services to use the techniques described herein. The claimed subject matter contemplates the use from the standpoint of an API (or other software object), as well as from a software or hardware object that operates according to the techniques set forth herein. Thus, various implementations of the claimed subject matter described herein may have aspects that are wholly in hardware, partly in hardware and partly in software, as well as in software.

The aforementioned systems have been described with respect to interaction between several components. It can be appreciated that such systems and components can include those components or specified sub-components, some of the specified components or sub-components, and additional components, and according to various permutations and combinations of the foregoing. Sub-components can also be implemented as components communicatively coupled to other components rather than included within parent components (hierarchical).

Additionally, it can be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the claimed subject matter may have been disclosed with respect to one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A method, comprising:
detecting an object in an input image, wherein the object is located within a bounding area;
extracting a physical location and a camera pose associated with the input image;
projecting a location coordinate of at least one entity onto the input image to obtain a projected point for the at least one entity, wherein the at least one entity is selected according to the physical location and camera pose associated with the input image;
determining that the projected point is a nearest projected point to the bounding area; and
labeling the object within the bounding area with an entity name of the at least one entity associated with the nearest projected point.

2. The method of claim 1, wherein the object is a structure.

3. The method of claim 1, wherein detecting the object comprises obtaining one or more candidate regions and classifying each proposed candidate region as containing an object or being a background region.

4. The method of claim 1, wherein the bounding area is defined by a location on an image plane and a size of the bounding area.

5. The method of claim 1, wherein the at least one entity is within a predetermined radius of the physical location associated with the input image.

6. The method of claim 1, wherein the object is detected according to a Faster R-CNN algorithm that detects a single class of objects.

7. The method of claim 1, wherein the location coordinate of the at least one entity is a GPS coordinate.

8. The method of claim 1, wherein the location coordinate of the at least one entity is stored in a geospatial data store that comprises geospatial data stored in a data structure that is formatted to enable an efficient nearest neighbor search.

9. The method of claim 1, wherein the entity name indicates a business organization that operates at the location coordinate of the at least one entity.

10. The method of claim 1, wherein the object is a building, landmark, church, monument, statue, road, or highway.

11. A system, comprising:
an object detector to detect an object in an input image, wherein the object is located within a bounding area;
a map infrastructure to extract a physical location and a camera pose associated with the input image; and
a label assignor to:
project a location coordinate of at least one entity onto the input image to obtain a projected point for the at least one entity, wherein the at least one entity is selected according to the physical location and camera pose associated with the input image;
determine that the projected point is a nearest projected point to the bounding area; and
label the object within the bounding area with an entity name of the at least one entity associated with the nearest projected point.

12. The system of claim 11, wherein the object is a structure.

13. The system of claim 11, wherein detecting the object comprises obtaining one or more candidate regions and classifying each proposed candidate region as containing an object or being a background region.

14. The system of claim 11, wherein the at least one entity is within a predetermined radius of the physical location associated with input image.

15. The system of claim 11, wherein the object is detected according to a Faster R-CNN algorithm that detects a single class of objects.

16. A computer readable medium bearing computer executable instructions which, when executed on a computing system comprising at least a processor, carry out a method for enable building recognition via object detection and geospatial intelligence, the method comprising, comprising:
detecting an object in an input image, wherein the object is located within a bounding area;
extracting a physical location and a camera pose associated with the input image;
projecting a location coordinate of at least one entity onto the input image to obtain a projected point for the at least one entity, wherein the at least one entity is selected according to the physical location and camera pose associated with the input image;
determining that the projected point is a nearest projected point to the bounding area; and
labeling the object within the bounding area with an entity name of the at least one entity associated with the nearest projected point.

17. The computer readable medium of claim 16, wherein detecting the object comprises obtaining one or more candidate regions, and classifying each proposed candidate region as containing an object or being a background region.

18. The computer readable medium of claim 16, wherein the location coordinate of the at least one entity is stored in a geospatial data store that comprises geospatial data stored in a data structure that is formatted to enable an efficient nearest neighbor search.

19. The computer readable medium of claim 16, wherein the entity name indicates a business organization that operates at the location occupied by the building.

20. The computer readable medium of claim 16, wherein the object is a building, landmark, church, monument, statue, road, or highway.
